(19) United States
(12) Patent Application Publication
(10) Pub. No.: US 2025/0096293 A1
(43) Pub. Date: Mar. 20, 2025

(54) FUEL CELL SYSTEM

(71) Applicant: TOYOTA JIDOSHA KABUSHIKI KAISHA, Toyota-shi Aichi-ken (JP)

(72) Inventor: Hiroshi FUJITANI, Toyota-shi Aichi-ken (JP)

(73) Assignee: TOYOTA JIDOSHA KABUSHIKI KAISHA, Toyota-shi Aichi-ken (JP)

(21) Appl. No.: 18/882,022

(22) Filed: Sep. 11, 2024

(30) Foreign Application Priority Data
Sep. 19, 2023 (JP) 2023-150793

(51) Int. Cl. H01M 8/04858; H01M 8/04029; H01M 8/0432; H01M 8/04537; H01M 8/04746

(52) U.S. Cl. CPC H01M 8/04947; H01M 8/04029; H01M 8/04358; H01M 8/04567; H01M 8/04768

(57) ABSTRACT

A fuel cell system capable of maintaining the output of the fuel cell system. A fuel cell system, wherein the fuel cell system includes: a fuel cell stack, a cooling flow path configured to circulate cooling water for cooling the fuel cell stack in and out of the fuel cell stack, a radiator disposed on the cooling flow path, a bypass flow path branching from the cooling flow path upstream of the radiator of the cooling flow path, bypassing the radiator, and merging with the cooling flow path downstream of the radiator of the cooling flow path, a switching valve disposed at a branch point of the cooling flow path to the bypass flow path, a power supply, a voltmeter, and a secondary battery.

### CROSS-REFERENCE TO RELATED APPLICATIONS

This application is based upon and claims the benefit of priority of the prior Japanese Patent Application No. 2023-150793, filed on Sep. 19, 2023, the entire contents of which are incorporated herein by reference.

### TECHNICAL FIELD

The present disclosure relates to a fuel cell system.

### BACKGROUND

Various studies have been proposed for fuel cells (FC) as disclosed in Patent Documents 1 and 2.
Patent Document 1: Japanese Patent Application Laid-Open (JP-A) No. 2009-170378
Patent Document 2: JP-A No. 2008-130424

In the prior art, the cooling water temperature of the fuel cell is controlled by a circuit including a water pump and a switching valve. In a fuel cell system, the motor torque of the cooling water switching valve fluctuates due to the voltage of the power supply. Accordingly, a sufficient motor torque cannot be obtained when the power supply voltage drops, and the responsiveness of the switching valve decreases. A decrease in the responsiveness of the switching valve lowers the output of the fuel cell, thereby lowering the output of the fuel cell system.

### SUMMARY

The disclosure was achieved in light of the above circumstances. An object of the disclosure is to provide a fuel cell system capable of maintaining the output of the fuel cell system.

In the first embodiment of the present disclosure, there is provided a fuel cell system,
wherein the fuel cell system comprises:
a fuel cell stack,
a cooling flow path configured to circulate cooling water
for cooling the fuel cell stack in and out of the fuel cell stack,
a radiator disposed on the cooling flow path,
a bypass flow path branching from the cooling flow path upstream of the radiator of the cooling flow path, bypassing the radiator, and merging with the cooling flow path downstream of the radiator of the cooling flow path,
a switching valve disposed at a branch point of the cooling flow path to the bypass flow path and configured to switch between flowing the cooling water, which is discharged from the fuel cell stack, to the radiator and flowing the cooling water to the bypass flow path,
a power supply configured to supply power to the switching valve,
a voltmeter configured to measure a voltage of the power supply, and
a secondary battery, and
wherein, when the voltage of the power supply measured by the voltmeter is equal to or higher than a predetermined voltage, an upper limit of output from the secondary battery is set to a first output, and when the voltage of the power supply is lower than the predetermined voltage, the upper limit of the output from the secondary battery is set to a second output which is larger than the first output.

According to the second embodiment of the present disclosure, in the first embodiment, a response time of the switching valve is estimated based on the voltage of the power supply measured by the voltmeter;
a temperature of the cooling water flowing into the fuel cell stack is estimated based on the response time; and
when the estimated cooling water temperature is equal to or lower than a predetermined temperature, the upper limit of the output from the secondary battery is set to the second output.

The present disclosure can maintain the output of the fuel cell system.

### BRIEF DESCRIPTION OF THE DRAWINGS

In the accompanying drawings,

FIG. 1 is a graph showing an example of a relationship between a pulse rate, a driving torque, and a power supply voltage;

FIG. 2 is a view showing an example of a ratio between the fuel cell output and the secondary battery output when the power supply voltage is high and when the power supply voltage is low;

FIG. 3 is a system configuration diagram showing an example of the fuel cell system of the present disclosure; and

FIG. 4 is a flowchart showing an example of the control of the fuel cell system of the present disclosure.

### DETAILED DESCRIPTION

Hereinafter, the embodiments of the present disclosure will be described in detail. Matters that are required to implement the present disclosure (such as common a fuel cell system structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relationships (length, width, thickness, and the like) in the drawings do not reflect actual dimensional relationships.

In the present disclosure, the gas supplied to the anode of the fuel cell is a fuel gas (anode gas), and the gas supplied to the cathode of the fuel cell is an oxidant gas (cathode gas). The fuel gas is a gas mainly containing hydrogen, and may be hydrogen. The oxidizing gas is a gas containing oxygen, and may be oxygen, air, or the like.

In the present disclosure, there is provided a fuel cell system,
wherein the fuel cell system comprises:
a fuel cell stack,
a cooling flow path configured to circulate cooling water for cooling the fuel cell stack in and out of the fuel cell stack,
a radiator disposed on the cooling flow path,
a bypass flow path branching from the cooling flow path upstream of the radiator of the cooling flow path, bypassing the radiator, and merging with the cooling flow path downstream of the radiator of the cooling flow path,
a switching valve disposed at a branch point of the cooling flow path to the bypass flow path and configured to switch between flowing the cooling water, which is discharged from the fuel cell stack, to the radiator and flowing the cooling water to the bypass flow path,
a power supply configured to supply power to the switching valve,
a voltmeter configured to measure a voltage of the power supply, and
a secondary battery, and
wherein, when the voltage of the power supply measured by the voltmeter is equal to or higher than a predetermined voltage, an upper limit of output from the secondary battery is set to a first output, and when the voltage of the power supply is lower than the predetermined voltage, the upper limit of the output from the secondary battery is set to a second output which is larger than the first output.

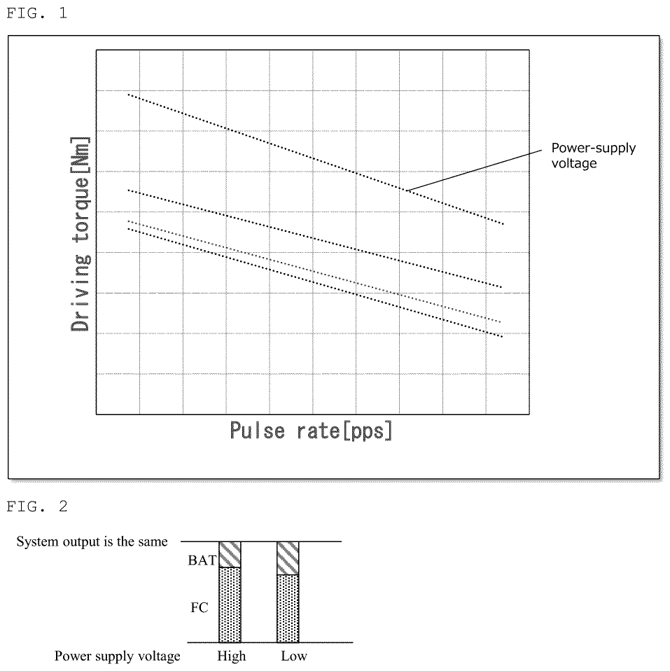

FIG. 1 is a graph showing an example of a relationship between a pulse rate, a driving torque, and a power supply voltage.

In the fuel cell system, since the motor torque (drive torque) of the switching valve of the cooling water fluctuates due to the power supply voltage as shown in FIG. 1, the motor torque does not sufficiently come out when the power supply voltage drops, the pulse rate of the switching valve of the cooling water decreases, and the responsiveness decreases. When the responsiveness of the switching valve is lowered, the switching of the cooling water from the radiator side to the bypass flow path side bypassing the radiator is delayed, and the temperature rise of the cooling water is delayed as compared with before the responsiveness is lowered, whereby the temperature of the cooling water flowing into the fuel cell is lowered, the inlet water temperature and the outlet water temperature of the fuel cell are lowered, and the output of the fuel cell is lowered at the time of acceleration of the vehicle or the like.

FIG. 2 is a view showing an example of a ratio between the fuel cell output and the secondary battery output when the power supply voltage is high and when the power supply voltage is low.

According to the present disclosure, when the voltage of the power supply for supplying power to the switching valve is less than the predetermined voltage, the output larger than the normal value is supplied from the secondary battery (Bat), whereby the reduced output of the fuel cell can be compensated, the output of the entire system can be maintained to obtain a predetermined system output, and the output from the secondary battery can be kept low in the normal state to suppress the deterioration of the secondary battery.

The fuel cell system of the present disclosure may be mounted on a moving body such as a vehicle and used. Further, the fuel cell system of the present disclosure may be mounted in a stationary power generation system such as a generator that supplies electric power to the outside of the fuel cell system.

The vehicle may be a fuel cell vehicle or the like. Examples of the moving body other than the vehicle include a railway, a ship, and an aircraft.

Further, the fuel cell system of the present disclosure may be mounted on a moving body such as a vehicle capable of traveling even with electric power of a secondary battery.

The mobile body and the stationary power generation system may include the fuel cell system of the present disclosure. The moving body may include a drive unit such as a motor, an inverter, and a hybrid control system.

The hybrid control system may be capable of driving a moving body by using both the output of the fuel cell and the electric power of the secondary battery.

The fuel cell system includes a fuel cell that generates power by reacting hydrogen and oxygen, a fuel gas system that supplies a fuel gas containing hydrogen necessary for power generation of the fuel cell to the fuel cell, an oxidant gas system that supplies an oxidant gas containing oxygen to the fuel cell, and a cooling system that supplies cooling water that cools heat generated by power generation to the fuel cell.

The fuel cell may have only one unit cell of the fuel cell, or may be a fuel cell stack which is a stack in which a plurality of unit cells are stacked.

In the present disclosure, both the unit cell and the fuel cell stack may be referred to as a fuel cell.

The number of stacked unit cells in the fuel cell stack is not particularly limited, and may be, for example, 2 to several hundred.

The fuel cell stack may include a current collector plate, a pressure plate, and the like at an end portion in the stacking direction.

The unit cell may include a power generation unit.

The shape of the power generation unit may be a rectangular shape in a plan view.

The power generation unit may be a membrane electrode assembly (MEA) including an electrolyte membrane and two electrodes.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The two electrodes are one anode (fuel electrode) and the other cathode (oxidant electrode).

The electrode includes a catalytic layer, and may optionally include a gas diffusion layer, and the power generation unit may be a membrane electrode gas diffusion layer assembly (MEGA).

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each of the catalyst layers, a support (catalyst-supported support) on which the catalyst metal is supported and an electrolyte may be mixed.

Examples of the support for supporting the catalyst metal include carbon materials such as carbon, which are generally commercially available.

The gas diffusion layer may be a conductive member or the like having pores.

Examples of the conductive member include a carbon porous body such as carbon cloth and carbon paper, and a metal porous member such as a metal mesh and a metal foam.

The unit cell of the fuel cell may include a separator.

The separator collects current generated by power generation and functions as a partition wall. In a unit cell of a fuel cell, the separator is usually disposed on both sides of the power generation unit in the stacking direction so that a pair of separators sandwich the power generation unit. One of the pair of separators is an anode separator and the other is a cathode separator.

The anode separator may have a groove that serves as a fuel gas flow path on a surface on the side of the power generation unit.

The cathode separator may have a groove that serves as an oxidant gas flow path on a surface on the side of the power generation unit.

The separator may have holes constituting a manifold such as a supply hole and a discharge hole for allowing fluid to flow in the stacking direction of the unit cells.

The separator may be, for example, dense carbon obtained by compressing carbon to make it impermeable to gas, and press-formed metal (for example, iron, titanium, stainless steel, and the like).

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and seals between the anode separator and the cathode separator in a condition where the membrane electrode assembly is held in a central region thereof. As the resin frame, for example, a resin such as PE, PP, PET, PEN can be used. The resin frame may be a three-layer sheet composed of three layers in which an adhesive layer is disposed on a surface layer.

The fuel cell system may include a control device. The control device may control the entire fuel cell system by controlling the oxidant gas system, the fuel gas system, the cooling system, and the like.

The control device physically includes, for example, an arithmetic processing unit such as a CPU (central processing unit), a ROM (read-only memory) that stores control programs and control data to be processed by CPU, a storage device such as a RAM (random access memory) that is mainly used as various working areas for the control processing, and an input/output interface, and may be an ECU (electronic control unit).

The cooling system supplies cooling water to the fuel cell as a cooling medium.

The cooling water may be water, ethylene glycol, or the like, or a mixture thereof.

The cooling system includes a cooling channel, a radiator, a bypass channel, and a switching valve, and may include a reserve tank, a cooling water pump, an ion exchanger, an intercooler, a temperature sensor, and the like as necessary.

The cooling flow path is a flow path for circulating cooling water for cooling the fuel cell stack inside and outside the fuel cell stack.

The radiator is disposed on the cooling flow path.

The bypass flow path branches from the cooling flow path upstream of the radiator of the cooling flow path, bypasses the radiator, and merges with the cooling flow path downstream of the radiator of the cooling flow path.

The switching valve is disposed at a branch point of the cooling flow path from the bypass flow path to switch whether the cooling water discharged from the fuel cell stack flows to the radiator or flows to the bypass flow path. The switching valve may include an electric motor such as an electric actuator for switching the flow path.

The cooling water pump adjusts a flow rate of the cooling water supplied to the fuel cell.

The fuel cell system includes a power source. The power supply supplies power to the switching valve.

The fuel cell system comprises a voltmeter. The voltmeter measures the voltage of the power supply.

The fuel cell system includes a secondary battery.

The secondary battery may be any battery that can be charged and discharged, and examples thereof include a nickel-hydrogen secondary battery and a conventionally known secondary battery such as a lithium-ion secondary battery. The secondary battery may include a power storage element such as an electric double layer capacitor. The secondary battery may have a configuration in which a plurality of the secondary batteries are connected in series. The secondary battery supplies electric power to a power source, an air compressor, and the like. The secondary battery may be rechargeable from an external power source of the fuel cell system, such as a household power source. The secondary battery may be charged by the output of the fuel cell. The charging and discharging of the secondary battery may be controlled by the control device.

When the voltage of the power supply measured by the voltmeter is equal to or higher than the predetermined voltage, the fuel cell system sets the output upper limit from the secondary battery to the first output. On the other hand, when the voltage of the power supply measured by the voltmeter is less than the predetermined voltage, the fuel cell system sets the output upper limit from the secondary battery to the second output that is larger than the first output. The first output and the second output are not particularly limited as long as the second output is larger than the first output, and can be appropriately set in consideration of the maximum output of the secondary battery, the maximum output of the fuel cell, and the like.

The fuel cell system may estimate the response time of the switching valve based on the voltage of the power supply measured by the voltmeter. Since the response time of the switching valve increases when the voltage of the power supply decreases, the fuel cell system may prepare in advance a data group indicating the relationship between the voltage of the power supply and the response time of the switching valve, and may estimate the response time of the switching valve by comparing the voltage of the power supply measured by the voltmeter with the data group.

The fuel cell system may estimate the temperature of the cooling water flowing into the fuel cell stack based on the estimated response time of the switching valve. When the response time of the switching valve becomes longer, the switching of the cooling water from the radiator side to the bypass flow path side bypassing the radiator becomes slower, and the temperature rise of the cooling water becomes slower than before the response time becomes longer (the response becomes lower), the temperature of the cooling water flowing into the fuel cell stack decreases, the inlet water temperature and the outlet water temperature of the fuel cell stack become lower, and the output of the fuel cell stack decreases. Therefore, the fuel cell system may prepare in advance a data group indicating the relationship between the response time of the switching valve and the temperature of the cooling water flowing into the fuel cell stack, and may estimate the temperature of the cooling water flowing into the fuel cell stack by comparing the response time of the estimated switching valve with the data group.

When the estimated temperature of the cooling water is equal to or lower than the predetermined temperature, the fuel cell system may set the output upper limit from the secondary battery to the second output, assuming that the output of the fuel cell stack is lowered.

According to the present disclosure, it is possible to perform output assistance in the secondary battery with higher accuracy without adding the temperature sensor by based on the water temperature of the cooling water that has estimated the determination of the necessity of output assistance in the secondary battery.

The oxidizing gas system supplies an oxidizing gas to the fuel cell and adjusts a flow rate of the oxidizing gas. The oxidant gas system may include an oxidant gas supply device, an oxidant gas pipe, an inlet-side sealing valve at an oxidant gas inlet of the fuel cell, an outlet-side sealing valve at an oxidant gas outlet of the fuel cell, and the like.

The oxidant gas supply device may be an air compressor or the like.

The fuel gas system supplies fuel gas to the fuel cell and regulates a flow rate of the fuel gas. The fuel gas system may include a fuel gas tank, a fuel gas inlet valve, an injector, a gas-liquid separator, a fuel gas purge valve, an ejector for circulating fuel gas, a fuel gas pump for circulating fuel gas, a fuel gas pipe, and the like.

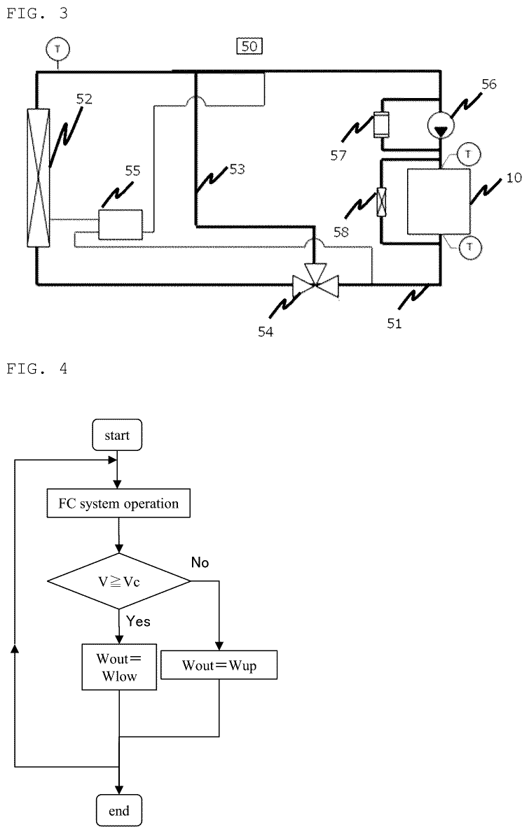

FIG. 3 is a system configuration diagram showing an example of the fuel cell system of the present disclosure.

The fuel cell system illustrated in FIG. 3 includes a fuel cell stack 10, a cooling system 50, and a temperature sensor T, and although not illustrated, the fuel cell system includes a power source, a voltmeter, a secondary battery, an oxidant gas system, and a fuel gas system. The cooling system 50 includes a cooling channel 51, a radiator 52, a bypass channel 53, a switching valve 54, a reserve tank 55, a cooling water pump 56, an ion exchanger 57, and an intercooler 58.

FIG. 4 is a flowchart showing an example of the control of the fuel cell system of the present disclosure.

An operation of the fuel cell system is started, and it is determined whether or not the supplied voltage V from the power supply is equal to or higher than a predetermined voltage threshold Vc.

When the supplied voltage from the power source is equal to or higher than Vc, the output Wout from the secondary batteries is set to the output upper limit Wlow.

On the other hand, when the supply voltage from the power supply is less than Vc, the output Wout from the secondary battery is set to an output upper limit Wup larger than the output upper limit Wlow, and when the supply voltage from the power supply is lower, the output from the secondary battery is increased.

The fuel cell system may continue to check the power supply voltage V in a predetermined cycle until the operation is stopped, and may terminate the control when the operation is stopped.

### REFERENCE SIGNS LIST

10. Fuel cell stack
50. Cooling system
51. Cooling passage
52. Radiator
53. Bypass passage
54. Switching valve
55. Reserve tank
56. Cooling water pump
57. Ion exchanger
58. Intercooler
T. Temperature sensor

1. A fuel cell system,
wherein the fuel cell system comprises:
a fuel cell stack,
a cooling flow path configured to circulate cooling water for cooling the fuel cell stack in and out of the fuel cell stack,
a radiator disposed on the cooling flow path,
a bypass flow path branching from the cooling flow path upstream of the radiator of the cooling flow path, bypassing the radiator, and merging with the cooling flow path downstream of the radiator of the cooling flow path,
a switching valve disposed at a branch point of the cooling flow path to the bypass flow path and configured to switch between flowing the cooling water, which is discharged from the fuel cell stack, to the radiator and flowing the cooling water to the bypass flow path,
a power supply configured to supply power to the switching valve,
a voltmeter configured to measure a voltage of the power supply, and
a secondary battery, and
wherein, when the voltage of the power supply measured by the voltmeter is equal to or higher than a predetermined voltage, an upper limit of output from the secondary battery is set to a first output, and when the voltage of the power supply is lower than the predetermined voltage, the upper limit of the output from the secondary battery is set to a second output which is larger than the first output.

2. The fuel cell system according to claim 1,
wherein a response time of the switching valve is estimated based on the voltage of the power supply measured by the voltmeter;
wherein a temperature of the cooling water flowing into the fuel cell stack is estimated based on the response time; and
wherein, when the estimated cooling water temperature is equal to or lower than a predetermined temperature, the upper limit of the output from the secondary battery is set to the second output.
